(19) United States
(12) Patent Application Publication
(10) Pub. No.: US 2010/0066609 A1
(43) Pub. Date: Mar. 18, 2010

(54) DIGITAL TELEVISION ANTENNA

(76) Inventors: Chung-Wen YANG, Tu-Cheng City (TW); Yu-Yuan Wu, Tu-Cheng City (TW); Hung-Jen Chen, Tu-Cheng City (TW)

Correspondence Address: Muncy, Geissler, Olds & Lowe, PLLC, P.O. BOX 1364, FAIRFAX, VA, 22038-1364, US

(21) Appl. No.: 12/210,417

(22) Filed: Sep. 15, 2008

(51) Int. Cl. H01Q 1/38

(52) U.S. Cl. 343/700 MS

(57) ABSTRACT

An antenna adapted for a digital television includes a base board defining a grounding region on a surface thereof, an antenna element made of conductive material and disposed on the base board, and a circuit disposed on the grounding region of the base board. The antenna element meanders like a plurality of series-connected zigzags along a lengthwise direction of the base board and gradually increases a transverse length thereof in process of meandering to show a substantially trapezoid outline. The circuit is electrically connected with one end of the antenna element having a shortest transverse length. That can increase frequency bandwidth of electromagnetic waves received, instead of extra metal parasitical elements. So the antenna can reduce the manufacture cost and make the structure simpler.

### BACKGROUND OF THE INVENTION

1. Field of the Invention

The present invention generally relates to an antenna, and more particularly to a digital television antenna.

2. The Related Art

A conventional digital television antenna includes a base board, an antenna element and a plurality of metal parasitical elements. The base board is a printed circuit board and one surface thereof has an antenna region and a grounding region. The antenna element is made of conductive material and meanders like a plurality of series-connected zigzags on the antenna region to show a rectangular outline. The parasitical elements are disposed on the other surface of the base board so as to increase frequency bandwidth of electromagnetic waves received by the antenna element. The antenna element is designed to meander like the series-connected zigzags in order to reduce a space occupied on the base board. However, the frequency bandwidth of the electromagnetic waves received by the conventional digital television antenna is increased by disposing the parasitical elements on the base board that increases the manufacture cost and makes the structure complicated.

### SUMMARY OF THE INVENTION

An object of the present invention is to provide an antenna adapted for a digital television. The antenna includes a base board defining a grounding region on a surface thereof, an antenna element made of conductive material and disposed on the base board, and a circuit disposed on the grounding region of the base board. The antenna element meanders like a plurality of series-connected zigzags along a lengthwise direction of the base board and gradually increases a transverse length thereof in process of meandering to show a substantially trapezoid outline. The circuit is electrically connected with one end of the antenna element having a shortest transverse length.

As described above, the antenna element is disposed to show a substantially trapezoid outline and the one end thereof having the shortest transverse length is connected with the circuit that increase frequency bandwidth of electromagnetic waves received, instead of extra metal parasitical elements. Therefore, the antenna can reduce the manufacture cost and make the structure simpler.

### BRIEF DESCRIPTION OF THE DRAWINGS

The present invention will be apparent to those skilled in the art by reading the following description of a preferred embodiment thereof, with reference to the attached drawings, in which:

FIG. 1 is a vertical view of a digital television antenna according to the present invention.

### DETAILED DESCRIPTION OF THE PREFERRED EMBODIMENT

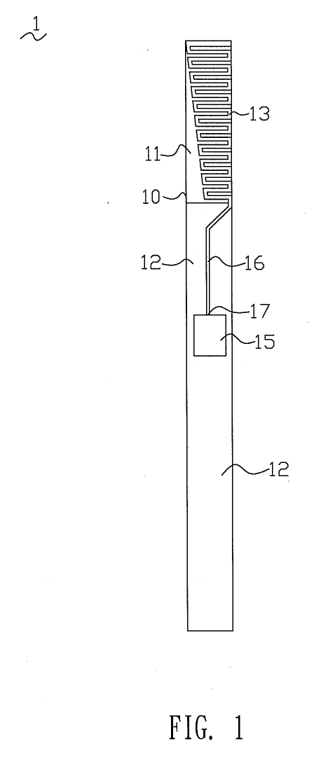

With reference to FIG. 1, a digital television antenna 1 according to the present invention includes a base board 10, an antenna element 13 and a circuit 15 respectively printed on the base board 10. In the embodiment, the base board 10 is a lengthwise rectangular printed circuit board disposed levelly. A top surface of the base board 10 is divided into two parts along a transverse direction thereof, wherein one part is an antenna region 11 at rear and the other part is a grounding region 12 at front.

The antenna element 13 is made of conductive material and meanders from front to rear like a plurality of series-connected zigzags to be printed on the antenna region 11 of the base board 10. A transverse length of the antenna element 13 is gradually increased in process of meandering for showing a right-angled trapezoid outline which has a right side printed along a right edge of the antenna region 11, thereby the antenna element 13 has a function increasing frequency bandwidth of electromagnetic waves received.

The circuit 15 is printed on the grounding region 12 of the base board 10 and includes an amplifier (not shown). The circuit 15 is electrically connected with one end of the antenna element 13 by a microstrip 16 printed on the grounding region 12, wherein the one end of the antenna element 13 is adjacent to the grounding region 12 and has a shortest transverse length. There is a feed point 17 defined at the junction of the microstrip 16 and the circuit 15.

In use, the electromagnetic waves are received by the antenna element 13 and then are transmitted into the circuit 15 by the microstrip 16 so as to be processed and amplified by the circuit 15. In the embodiment, the digital television antenna 1 is designed to receive the electromagnetic waves having the frequency bandwidth of 533 MHz to 599 MHz.

As described above, the antenna element 13 is designed to gradually increase the transverse length thereof in process of being far away from the grounding region 12 for showing the right-angled trapezoid outline in order to increase the frequency bandwidth of the electromagnetic waves received, instead of extra metal parasitical elements. Therefore, the digital television antenna 1 can reduce the manufacture cost and make the structure simpler. Furthermore, the dimension of the grounding region 12 can be regulated so as to achieve an optimum antenna gain.

What is claimed is:

1. An antenna adapted for a digital television, comprising:
a base board defining a grounding region on a surface thereof;
an antenna element made of conductive material and disposed on the base board, the antenna element meandering like a plurality of series-connected zigzags along a lengthwise direction of the base board and gradually increasing a transverse length thereof in process of meandering to show a substantially trapezoid outline; and
a circuit disposed on the grounding region of the base board and electrically connected with one end of the antenna element having a shortest transverse length.

2. The antenna as claimed in claim 1, wherein the base board further defines an antenna region on the same surface as the grounding region, the antenna region and the grounding region are divided along a transverse direction of the base board, the antenna element is disposed on the antenna region and the one end thereof having the shortest transverse length is adjacent to the grounding region.

3. The antenna as claimed in claim 1, wherein the dimension of the grounding region can be regulated to change an antenna gain.

4. The antenna as claimed in claim 1, wherein the base board is a printed circuit board, the antenna element and the circuit are respectively printed on the base board.

5. The antenna as claimed in claim 1, wherein the circuit and the antenna element are electrically connected with each other by a microstrip, a feed point is defined at the junction of the circuit and the microstrip.

6. The antenna as claimed in claim 1, wherein the antenna element shows a substantially right-angled trapezoid outline.
